(19) United States
(12) Patent Application Publication
(10) Pub. No.: US 2025/0348467 A1
(43) Pub. Date: Nov. 13, 2025

(54) SYSTEMS AND METHODS FOR LIVE PROCESSING OF DATA

(71) Applicant: Fidelity Information Services, LLC, Jacksonville, FL (US)

(72) Inventors: Ranadhir GHOSH, St Johns, FL (US); John C. PLATAIS, Menomonee Falls, WI (US); Abhinav SHARMA, Pune (IN)

(21) Appl. No.: 18/660,359

(22) Filed: May 10, 2024

(51) Int. Cl. G06F 16/21; G06F 16/953

(52) U.S. Cl. CPC G06F 16/213; G06F 16/953

(57) ABSTRACT

A method for live processing of data is disclosed. The method may include receiving data from a data source. The method may further include storing the data in an in-memory database. The method may further include retrieving the data from the in-memory database according to a custom schema, in response to a request from a user interface; and. The method may further include transmitting, by the computing system, the data to a web client.

### TECHNICAL FIELD

The present disclosure relates generally to the field of information technology (IT) management systems, and, more particularly, to systems and methods for live processing of data.

### BACKGROUND

Live data processing involves handling & analyzing data in real-time as it is generated or received, enabling immediate insights and actions. This may be crucial in scenarios where timely information is essential such as in monitoring systems, financial transactions, and the like. Therefore, live data processing may minimize delays in processing and provide the most up-to date information to a user. The traditional approach of client server communication involves the use of the representational state transfer (REST) protocol to fetch data from the server and pass it to the client as a JSON file, or the like. This includes creating application programming interfaces (APIs) using NodeJS (JavaScript), Flask (Python), or the like. However, one of the main drawbacks of using REST APIs is over-fetching and under-fetching of data. Because REST APIs have a fixed structure of data, the client would end up with either additional data (over-fetching) or less data (under-fetching).

For example, in the case of over-fetching, consider an endpoint “/users” that returns information about users, including their usernames, email, addresses and registration dates. If, within a specific user interface (UI) component, the user only needs the usernames of the users, using the “/users” endpoint would result in over-fetching, or getting more data than required.

In another example, in the case of under-fetching, consider an endpoint “/posts” that provides information about blog posts, including post title, content, the user who created the post, and the date and time when the post was created. If only the posts without the user details are fetched, and a user later needs information about the users who created those posts, the user may need to make additional requests to the “/users” endpoint, as the initial request for posts did not include the desired data.

The present disclosure is directed to addressing this and other drawbacks to the existing computing system incident analysis techniques.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques describe herein relate to a computer implemented method for live processing of data that may include receiving data from a data source. The method may further include storing the data in an in-memory database. The method may further include retrieving the data from the in-memory database according to a custom schema, in response to a request from a user interface; and. The method may further include transmitting, by the computing system, the data to a web client.

In some aspects, the techniques described herein relate to a system for live processing of data. The system may include a memory storing instructions and a processor operatively connected to the memory and configured to execute the instructions to perform operations. The operations may include receiving data from a data source. The operations may further include storing the data in an in-memory database. The operations may further include retrieving the data from the in-memory database according to a custom schema, in response to a request from a user interface. The operations may further include transmitting the data to a web client.

In some aspects, the techniques described herein relate to a non-transitory computer-readable medium storing instructions that, when executed by one or more processors, perform operations. The operations may include receiving data from a data source. The operations may further include storing the data in an in-memory database. The operations may further include retrieving the data from the in-memory database according to a custom schema, in response to a request from a user interface. The operations may further include transmitting the data to a web client.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1 depicts an exemplary system overview for a data pipeline for an artificial intelligence model to predict and troubleshoot incidents in a system, according to one or more embodiments.

FIG. 2 depicts an exemplary data flow diagram of a system for live processing of data, according to one or more embodiments.

FIG. 3 depicts an exemplary flowchart of a method for live processing of data, according to one or more embodiments.

FIG. 4 depicts a computer system for executing the techniques described herein, according to one or more embodiments of the present disclosure.

### DETAILED DESCRIPTION OF EMBODIMENTS

The present disclosure relates generally to the field of information technology (IT) management systems, and, more particularly, to systems and methods for live processing of data.

The subject matter of the present disclosure will now be described more fully with reference to the accompanying drawings that show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Systems and methods described below may utilize in-memory data storage and a data query system. In various embodiments, storing data in-memory (e.g., such as a Redis database) allows for rapid access to and retrieval of data. Further, using a data query system may allow for a faster and more efficient mode of communication between servers and clients, which may allow near real-time updates as soon as the data reaches the database, as well as preventing over-fetching or under-fetching of data. Additionally, in-memory storage stores data in system's random access memory (RAM), which is faster to access compared to traditional disk-based storage. This speed may be crucial for live data processing scenarios where the real-time or near-real-time responses are required. Retrieving data from memory is low latency compared to fetching from disk storage. This may be particularly important for applications that demand quick response times, such as real-time monitoring or analytics systems. In-memory storage is efficient for applications that have heavy read operations. In real-time processing applications, frequent analysis is needed promptly. Further, the in-memory storage can be scaled horizontally by adding more servers or nodes providing scalability for handling increasing data loads. In-memory storage also acts as a natural cache, reducing the need to repeatedly fetch data from slow, persistent storage.

Additionally, using a data query system, a custom schema may be used to fetch and display data for both a landing page and an incident details component. For example, the landing page may request the fields it needs to show the information, and the details page may use only the fields that it needs using the same custom schema that has been defined for the incident. In the future, if the user tries to come up with a new component which requires additional fields, the user would just need to update the custom schema with the new fields. The new UI component may therefore leverage those fields without affecting existing APIs. The APIs would be exposed by the data query system under a single endpoint (e.g., “/graphql”). Within these endpoints, there may be separate resolver functions which would handle the request based on the parameters passed to “/graphql.”

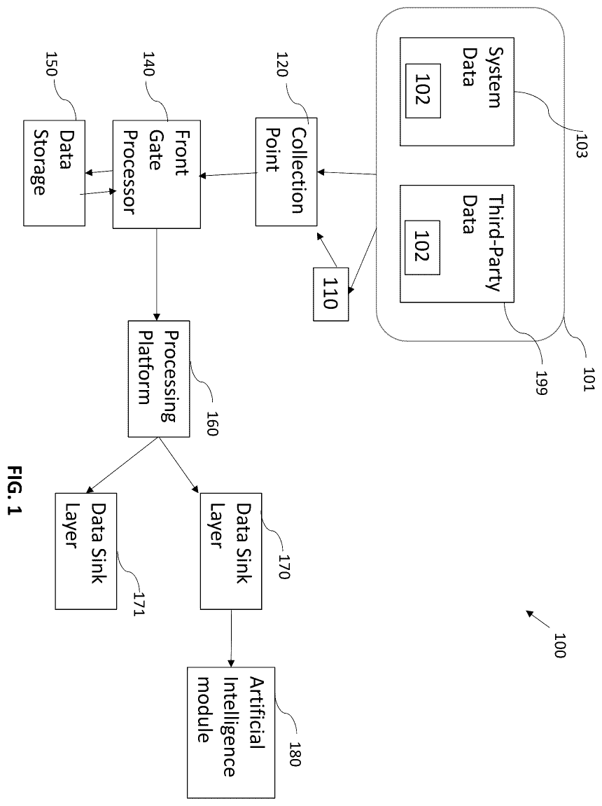

FIG. 1 depicts an exemplary system overview for a data pipeline for an artificial intelligence model to predict and troubleshoot incidents in a system, according to one or more embodiments. In various implementations, the live processing of data may occur after or during the data passes through the illustrated pipeline. In other words, the data may be retrieved using the disclosed systems and method after being gathered and/or processed by exemplary system 100. The data pipeline system 100 may be a platform with multiple interconnected components. The data pipeline system 100 may include one or more servers, intelligent networking devices, computing devices, components, and corresponding software for aggregating and processing data.

As shown in FIG. 1, a data pipeline system 100 may include a data source 101, a collection point 120, a secondary collection point 110, a front gate processor 140, data storage 150, a processing platform 160, a data sink layer 170, a data sink layer 171, and an artificial intelligence module 180. The data source 101 may include in-house data 103 and third party data 199. The in-house data 103 may be a data source directly linked to the data pipeline system 100. Third party data 199 may be a data source connected to the data pipeline system 100 externally as will be described in greater detail below.

Both the in-house data 103 and third party data 199 of the data source 101 may include incident data 102. Incident data 102 may include incident reports with information for each incident provided with one or more of an incident number, closed date/time, category, close code, close note, long description, short description, root cause, or assignment group. Incident data 102 may include incident reports with information for each incident provided with one or more of an issue key, description, summary, label, issue type, fix version, environment, author, or comments. Incident data 102 may include incident reports with information for each incident provided with one or more of a file name, script name, script type, script description, display identifier, message, committer type, committer link, properties, file changes, or branch information. Incident data 102 may include one or more of real-time data, market data, performance data, historical data, utilization data, infrastructure data, or security data. These are merely examples of information that may be used as data, and the disclosure is not limited to these examples.

Incident data 102 may be generated automatically by monitoring tools that generate alerts and incident data to provide notification of high-risk actions, failures in IT environment, and may be generated as tickets. Incident data may include metadata, such as, for example, text fields, identifying codes, and time stamps.

The in-house data 103 may be stored in a relational database including an incident table. The incident table may be provided as one or more tables, and may include, for example, one or more of problems, tasks, risk conditions, incidents, or changes. The relational database may be stored in a cloud. The relational database may be connected through encryption to a gateway. The relational database may send and receive periodic updates to and from the cloud. The cloud may be a remote cloud service, a local service, or any combination thereof. The cloud may include a gateway connected to a processing API configured to transfer data to the collection point 120 or a secondary collection point 110. The incident table may include incident data 102.

Data pipeline system 100 may include third party data 199 generated and maintained by third party data producers. Third party data producers may produce incident data 102 from Internet of Things (IoT) devices, desktop-level devices, and sensors. Third party data producers may include but are not limited to Tryambak, Appneta, Oracle, Prognosis, ThousandEyes, Zabbix, ServiceNow, Density, Dyatrace, etc. The incident data 102 may include metadata indicating that the data belongs to a particular client or associated system.

The data pipeline system 100 may include a secondary collection point 110 to collect and pre-process incident data 102 from the data source 101. The secondary collection point 110 may be utilized prior to transferring data to a collection point 120. The secondary collection point 110 point may for example be an Apache Minifi software. In one example, the secondary collection point 110 may run on a microprocessor for a third party data producer. Each third party data producer may have an instance of the secondary collection point 110 running on a microprocessor. The secondary collection point 110 may support data formats including but limited to JSON, CSV, Avro, ORC, HTML, XML, and Parquet. The secondary collection point 110 may encrypt incident data 102 collected from the third party data producers. The secondary collection point 110 may encrypt incident data, including, but not limited to, Mutual Authentication Transport Layer Security (mTLS), HTTPs, SSH, PGP, IPsec, and SSL. The secondary collection point 110 may perform initial transformation or processing of incident data 102. The secondary collection point 110 may be configured to collect data from a variety of protocols, have data provenance generated immediately, apply transformations and encryptions on the data, and prioritize data.

The data pipeline system 100 may include a collection point 120. The collection point 120 may be a system configured to provide a secure framework for routing, transforming, and delivering data across from the data source 101 to downstream processing devices (e.g., the front gate processor 140). The collection point 120 may for example be a software such as Apache NiFi. The collection point 120 may receive raw data and the data's corresponding fields such as the source name and ingestion time. The collection point 120 may run on a Linux Virtual Machine (VM) on a remote server. The collection point 120 may include one or more nodes. For example, the collection point 120 may receive incident data 102 directly from the data source 101. In another example, the collection point 120 may receive incident data 102 from the secondary collection point 110. The secondary collection point 110 may transfer the incident data 102 to the collection point 120 using, for example, Site-to-Site protocol. The collection point 120 may include a flow algorithm. The flow algorithm may connect different processors, as described herein, to transfer and modify data from one source to another. For each third party data producer, the collection point 120 may have a separate flow algorithm. Each flow algorithm may include a processing group. The processing group may include one or more processors. The one or more processors may, for example, fetch incident data 102 from the relational database. The one or more processors may utilize the processing API of the in-house data 103 to make an API call to a relational database to fetch incident data 102 from the incident table. The one or more processors may further transfer incident data 102 to a destination system such as a front gate processor 140. The collection point 120 may encrypt data through HTTPS, Mutual Authentication Transport Layer Security (mTLS), SSH, PGP, IPsec, and/or SSL, etc. The collection point 120 may support data formats including but not limited to JSON, CSV, Avro, ORC, HTML, XML, and Parquet. The collection point 120 may be configured to write messages to clusters of a front gate processor 140 and communication with the front gate processor 140.

The data pipeline system 100 may include a distributed event streaming platform such as a front gate processor 140. The front gate processor 140 may be connected to and configured to receive data from the collection point 120. The front gate processor 140 may be implemented in an Apache Kafka cluster software system. The front gate processor 140 may include one or more message brokers and corresponding nodes. The message broker may for example be an intermediary computer program module that translates a message from the formal messaging protocol of the sender to the formal messaging protocol of the receiver. The message broker may be on a single node in the front gate processor 140. A message broker of the front gate processor 140 may run on a virtual machine (VM) on a remote server. The collection point 120 may send the incident data 102 to one or more of the message brokers of the front gate processor 140. Each message broker may include a topic to store similar categories of incident data 102. A topic may be an ordered log of events. Each topic may include one or more sub-topics. For example, one sub-topic may store incident data 102 relating to network problems and another topic may store incident data 102 related to security breaches from third party data producers. Each topic may further include one or more partitions. The partitions may be a systematic way of breaking the one topic log file into many logs, each of which can be hosted on a separate server. Each partition may be configured to store as much as a byte of incident data 102. Each topic may be partitioned evenly between one or more message brokers to achieve load balancing and scalability. The front gate processor 140 may be configured to categorize the received data into a plurality of client categories, thereby forming a plurality of datasets associated with the respective client categories. These datasets may be stored separately within the storage device as described in greater detail below. The front gate processor 140 may further transfer data to storage and to processors for further processing.

For example, the front gate processor 140 may be configured to assign particular data to a corresponding topic. Alert sources may be assigned to an alert topic, and incident data may be assigned to an incident topic. Change data may be assigned to a change topic. Problem data may be assigned to a problem topic.

The data pipeline system 100 may include a software framework for data storage 150. The data storage 150 may be configured for long term storage and distributed processing. The data storage 150 may be implemented using, for example, Apache Hadoop. The data storage 150 may store incident data 102 transferred from the front gate processor 140. In particular, data storage 150 may be utilized for distributed processing of incident data 102, and Hadoop distributed file system (HDFS) within the data storage may be used for organizing communications and storage of incident data 102. For example, the HDFS may replicate any node from the front gate processor 140. This replication may protect against hardware or software failures of the front gate processor 140. The processing may be performed in parallel on multiple servers simultaneously.

The data storage 150 may include an HDFS that is configured to receive the metadata (e.g., incident data). The data storage 150 may further process the data utilizing a MapReduce algorithm. The MapReduce algorithm may allow for parallel processing of large data sets. The data storage 150 may further aggregate and store the data utilizing Yet Another Resource Negotiation (YARN). YARN may be used for cluster resource management and planning tasks of the stored data. For example, a cluster computing framework, such as the processing platform 160, may be arranged to further utilize the HDFS of the data storage 150. For example, if the data source 101 stops providing data, the processing platform 160 may be configured to retrieve data from the data storage 150 either directly or through the front gate processor 140. The data storage 150 may allow for the distributed processing of large data sets across clusters of computers using programming models. The data storage 150 may include a master node and an HDFS for distributing processing across a plurality of data nodes. The master node may store metadata such as the number of blocks and their locations. The main node may maintain the file system namespace and regulate client access to said files. The main node may comprise files and directories and perform file system executions such as naming, closing, and opening files. The data storage 150 may scale up from a single server to thousands of machines, each offering local computation and storage. The data storage 150 may be configured to store the incident data in an unstructured, semi-structured, or structured form. In one example, the plurality of datasets associated with the respective client categories may be stored separately. The master node may store the metadata such as the separate dataset locations.

The data pipeline system 100 may include a real-time processing framework, e.g., a processing platform 160. In one example, the processing platform 160 may be a distributed dataflow engine that does not have its own storage layer. For example, this may be the software platform Apache Flink. In another example, the software platform Apache Spark may be utilized. The processing platform 160 may support stream processing and batch processing. Stream processing may be a type of data processing that performs continuous, real-time analysis of received data. Batch processing may involve receiving discrete data sets processed in batches. The processing platform 160 may include one or more nodes. The processing platform 160 may aggregate incident data 102 (e.g., incident data 102 that has been processed by the front gate processor 140) received from the front gate processor 140. The processing platform 160 may include one or more operators to transform and process the received data. For example, a single operator may filter the incident data 102 and then connect to another operator to perform further data transformation. The processing platform 160 may process incident data 102 in parallel. A single operator may be on a single node within the processing platform 160. The processing platform 160 may be configured to filter and only send particular processed data to a particular data sink layer. For example, depending on the data source of the incident data 102 (e.g., whether the data is in-house data 103 or third party data 199), the data may be transferred to a separate data sink layer (e.g., data sink layer 170, or data sink layer 171). Further, additional data that is not required at downstream modules (e.g., at the artificial intelligence module 180) may be filtered and excluded prior to transferring the data to a data sink layer.

The processing platform 160 may perform three functions. First, the processing platform 160 may perform data validation. The data's value, structure, and/or format may be matched with the schema of the destination (e.g., the data sink layer 170). Second, the processing platform 160 may perform a data transformation. For example, a source field, target field, function, and parameter from the data may be extracted. Based upon the extracted function of the data, a particular transformation may be applied. The transformation may reformat the data for a particular use downstream. A user may be able to select a particular format for downstream use. Third, the processing platform 160 may perform data routing. For example, the processing platform 160 may select the shortest and/or most reliable path to send data to a respective sink layer (e.g., sink layer 170 and/or sink layer 171).

In one example, the processing platform 160 may be configured to transfer particular sets of data to a data sink layer. For example, the processing platform 160 may receive input variables for a particular artificial intelligence module 180. The processing platform 160 may then filter the data received from the front gate processor 140 and only transfer data related to the input variables of the artificial intelligence module 180 to a data sink layer.

The data pipeline system 100 may include one or more data sink layers (e.g., data sink layer 170 and data sink layer 171). Incident data 102 processed from processing platform 160 may be transmitted to and stored in data sink layer 170. In one example, the data sink layer 171 may be stored externally on a particular client's server. The data sink layer 170 and data sink layer 171 may be implemented using a software such as, but not limited to, PostgreSQL, HIVE, Kafka, OpenSearch, and Neo4j. The data sink layer 170 may receive in-house data 103, which have been processed and received from the processing platform 160. The data sink layer 171 may receive third party data 199, which have been processed and received from the processing platform 160. The data sink layers may be configured to transfer incident data 102 to an artificial intelligence module 180. The data sink layers may be data lakes, data warehouses, or cloud storage systems. Each data sink layer may be configured to store incident data 102 in both a structured or unstructured format. Data sink layer 170 may store incident data 102 with several different formats. For example, data sink layer 170 may support data formats such as JavaScript Objection Notation (JSON), comma-separated value (CSV), Avro, Optimized Row Columnar (ORC), Hypertext Markup Language (HTML), Extensible Markup Language (XML), or Parquet, etc. The data sink layer (e.g., data sink layer 170 or data sink layer 171), may be accessed by one or more separate components. For example, the data sink layer may be accessed by a Non-structured Query language (“NoSQL”) database management system (e.g., a Cassandra cluster), a graph database management system (e.g., Neo4j cluster), further processing programs (e.g., Kafka+Flink programs), and a relation database management system (e.g., postgres cluster). Further processing may thus be performed prior to the processed data being received by an artificial intelligence module 180.

The data pipeline system 100 may include an artificial intelligence module 180. The artificial intelligence module 180 may include a machine-learning component. The artificial intelligence module 180 may use the received data in order to train and/or use a machine learning model. The machine learning model may be, for example, a neural network. Nonetheless, it should be noted that other machine learning techniques and frameworks may be used by the artificial intelligence module 180 to perform the methods contemplated by the present disclosure. For example, the systems and methods may be realized using other types of supervised and unsupervised machine learning techniques such as regression problems, random forest, cluster algorithms, principal component analysis (PCA), reinforcement learning, or a combination thereof. The artificial intelligence module 180 may be configured to extract and receive data from the data sink layer 170.

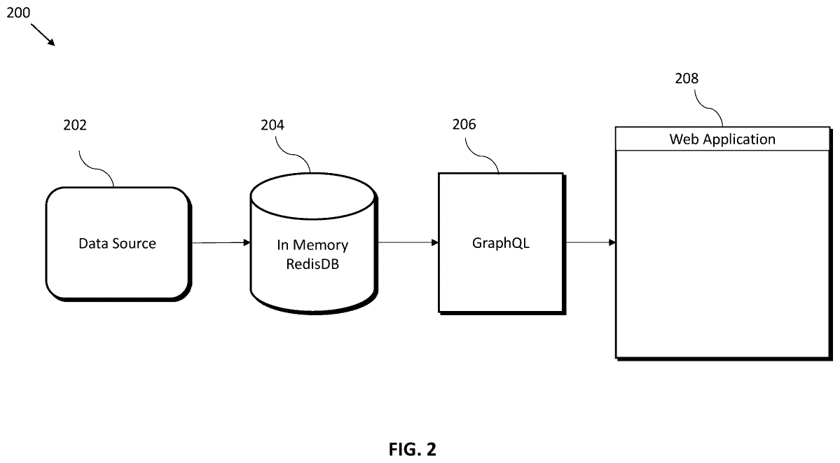

FIG. 2 depicts an exemplary data flow diagram of a system for live processing of data. As illustrated, the data may be received from data source 202. The data may represent analyzed or processed data that was analyzed or processed by components of the system, such as those depicted in FIG. 1. In examples, the data may be related to computing incidents. From the data source, the data may be placed within an in-memory database 204. In examples, the in-memory database 204 may be a main memory database (MMDB), an in-memory database system (IMDS), a real-time database system (RTDB), a cache, or the like.

In response to a request by a user, the data may be retrieved by data query system 206. As described above, data query system 206 may allow a user to request only the required data (e.g., preventing over-fetching and/or under-fetching of data). In this way, data may be fetched from multiple data sources with a single API call. A custom schema may be used that outlines the needed fields, and only the needed fields. The data query system 206 may be implemented as a GraphQL system, or the like. The retrieved data may then be transmitted to a web application 208 on a user interface. The web application may be configured to run on a user device that includes the user interface.

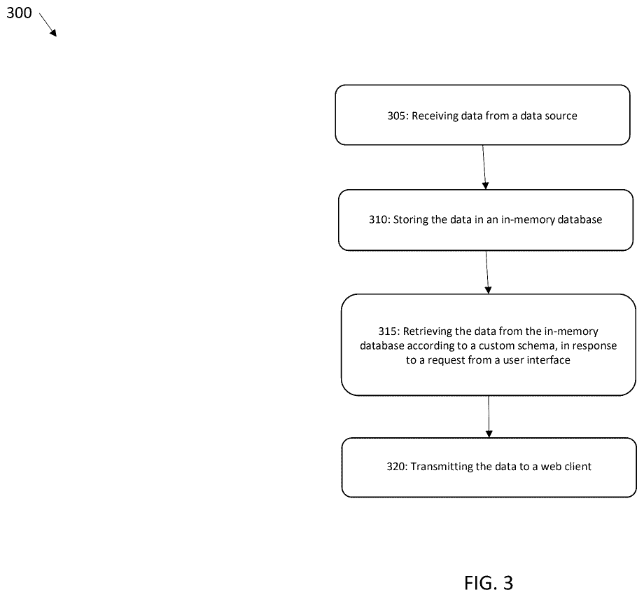

FIG. 3 depicts an exemplary flowchart of a method for live processing of data. Exemplary method 300 begins at step 305, wherein data is received from a data source. As described above, the data may be related to computing incidents and may be data analyzed from one or more computing incidents. In examples, the data may be associated with a presentation layer. In other examples, the day may include analyzed data from a plurality of computing incidents. At step 310, the data is stored in an in-memory database. As described above, the in-memory database may be implemented on a client device, allowing for real-time access to the data. At step 315, the data is retrieved from the in-memory database according to a custom schema, in response to a request from a user interface. The custom schema may include independently selected query fields where only the needed fields are included in the schema.

In examples, the request from the user may be transmitted to a data query system via a web server. In other examples, the request from the user may be transmitted via an application programming interface (API). In examples, the custom schema may be generated by components of the system as described with regard to FIG. 1. Generating the custom schema may include selecting one or more independently selectable query fields. In examples, generating the custom schema may prevent over-fetching and/or under-fetching of the data. At step 320, the data is transmitted to a web client.

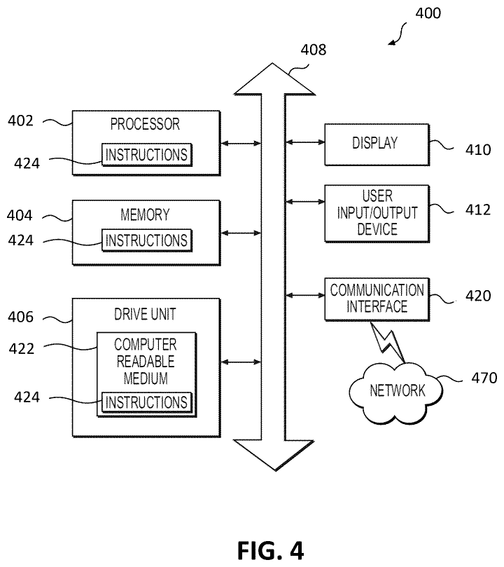

FIG. 4 depicts a computer system for executing the techniques described herein, according to one or more embodiments of the present disclosure. As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 404 includes a cache or random-access memory for the processor 402. In alternative implementations, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel payment and the like.

As shown, the computer system 400 may further include a display unit 410, such as a liquid crystal display (LCD), an organic light emitting diode (OLED), a flat panel display, a solid-state display, a cathode ray tube (CRT), a projector, a printer or other now known or later developed display device for outputting determined information. The display 410 may act as an interface for the user to see the functioning of the processor 402, or specifically as an interface with the software stored in the memory 404 or in the drive unit 406.

Additionally or alternatively, the computer system 400 may include an input device 412 configured to allow a user to interact with any of the components of system 400. The input device 412 may be a number pad, a keyboard, or a cursor control device, such as a mouse, or a joystick, touch screen display, remote control, or any other device operative to interact with the computer system 400.

The computer system 400 may also or alternatively include a disk or optical drive unit 406. The disk drive unit 406 may include a computer-readable medium 422 in which one or more sets of instructions 424, e.g., software, can be embedded. Further, the instructions 424 may embody one or more of the methods or logic as described herein. The instructions 424 may reside completely or partially within the memory 404 and/or within the processor 402 during execution by the computer system 400. The memory 404 and the processor 402 also may include computer-readable media as discussed above.

In some systems, a computer-readable medium 422 includes instructions 424 or receives and executes instructions 424 responsive to a propagated signal so that a device connected to a network 470 can communicate voice, video, audio, images, or any other data over the network 470. Further, the instructions 424 may be transmitted or received over the network 470 via a communication port or interface 420, and/or using a bus 408. The communication port or interface 420 may be a part of the processor 402 or may be a separate component. The communication port 420 may be created in software or may be a physical connection in hardware. The communication port 420 may be configured to connect with a network 470, external media, the display 410, or any other components in system 400, or combinations thereof. The connection with the network 470 may be a physical connection, such as a wired Ethernet connection or may be established wirelessly as discussed below. Likewise, the additional connections with other components of the system 400 may be physical connections or may be established wirelessly. The network 470 may alternatively be directly connected to the bus 608.

While the computer-readable medium 422 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 422 may be non-transitory, and may be tangible.

The computer-readable medium 422 can include a solid-state memory such as a memory card or other package that houses one or more non-volatile read-only memories. The computer-readable medium 422 can be a random-access memory or other volatile re-writable memory. Additionally or alternatively, the computer-readable medium 422 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 400 may be connected to one or more networks 470. The network 470 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 470 may include wide area networks (WAN), such as the Internet, local area networks (LAN), campus area networks, metropolitan area networks, a direct connection such as through a Universal Serial Bus (USB) port, or any other networks that may allow for data communication. The network 470 may be configured to couple one computing device to another computing device to enable communication of data between the devices. The network 470 may generally be enabled to employ any form of machine-readable media for communicating information from one device to another. The network 470 may include communication methods by which information may travel between computing devices. The network 470 may be divided into sub-networks. The sub-networks may allow access to all of the other components connected thereto or the sub-networks may restrict access between the components. The network 470 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel payment. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP, etc.) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosed embodiments are not limited to any particular implementation or programming technique and that the disclosed embodiments may be implemented using any appropriate techniques for implementing the functionality described herein. The disclosed embodiments are not limited to any particular programming language or operating system.

It should be appreciated that in the above description of exemplary embodiments, various features of the embodiments are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that a claimed embodiment requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment.

Furthermore, while some embodiments described herein include some but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the function.

In the description provided herein, numerous specific details are set forth. However, it is understood that embodiments of the present disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the present disclosure, those skilled in the art will recognize that other and further modifications may be made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

1. A method for live processing of data, the method comprising:
receiving, by a computing system, data from a data source, wherein the data includes notification of a failure in the computing system;
storing, by the computing system, the data in an in-memory database, wherein the in-memory database allows faster access to the data than the data source;
automatically selecting, by the computing system, one or more selectable query fields, to thereby automatically generate a custom schema associated with the notification of the failure in the computing system;
retrieving, by the computing system, the data from the in-memory database according to the custom schema, in response to a request from a user interface, thereby avoiding over-fetching or under-fetching the data; and
transmitting, by the computing system, the data to a web client, in accordance with the automatically generated custom schema.

2. The method of claim 1, wherein the data is associated with a presentation layer of the user interface.

3. The method of claim 1, wherein the request from the user is transmitted to a data query system via a web server.

4. The method of claim 1, wherein the data comprises analyzed data from a plurality of computing incidents.

5. The method of claim 1, wherein the request from the user is transmitted via an application programming interface (API).

6-8. (canceled)

9. A system for live processing of data, the system comprising:
a memory storing instructions and a processor operatively connected to the memory and configured to execute the instructions to perform operations including:
receiving, by a computing system, data from a data source, wherein the data includes notification of a failure in the computing system;
storing, by the computing system, the data in an in-memory database, wherein the in-memory database allows faster access to the data than the data source;
automatically selecting, by the computing system, one or more selectable query fields, to thereby generate a custom schema associated with the notification of the failure in the computing system;
retrieving, by the computing system, the data from the in-memory database according to the custom schema, in response to a request from a user interface, thereby avoiding over-fetching or under-fetching the data; and
transmitting, by the computing system, the data to a web client, in accordance with the automatically generated custom schema.

10. The system of claim 9, wherein the data is associated with a presentation layer of the user interface.

11. The system of claim 9, wherein the request from the user is transmitted to a data query system via a web server.

12. The system of claim 9, wherein the data comprises analyzed data from a plurality of computing incidents.

13. The system of claim 9, wherein the request from the user is transmitted via an application programming interface (API).

14-16. (canceled)

17. A non-transitory computer-readable medium storing instructions that, when executed by one or more processors, perform operations including:
receiving, by a computing system, data from a data source, wherein the data includes notification of a failure in the computing system;
storing, by the computing system, the data in an in-memory database, wherein the in-memory database allows faster access to the data than the data source;
automatically selecting, by the computing system, one or more selectable query fields, to thereby automatically generate a custom schema associated with the notification of the failure in the computing system;
retrieving, by the computing system, the data from the in-memory database according to the custom schema, in response to a request from a user interface, thereby avoiding over-fetching or under-fetching the data; and
transmitting, by the computing system, the data to a web client, in accordance with the automatically generated custom schema.

18. The system of claim 17, wherein the data is associated with a presentation layer of the user interface.

19. The system of claim 17, wherein the request from the user is transmitted to a data query system via a web server.

20. The system of claim 17, wherein the data comprises analyzed data from a plurality of computing incidents.
